(19) United States
(12) Patent Application Publication
(10) Pub. No.: US 2014/0174150 A1
(43) Pub. Date: Jun. 26, 2014

(54) LEAK DETECTION METHOD OF BATTERY MODULE AND THE BATTERY MODULE

(71) Applicant: Automotive Energy Supply Corporation, Zama-shi (JP)

(72) Inventor: Hisamichi YAJIMA, Atsugi-shi (JP)

(73) Assignee: Automotive Energy Supply Corporation, Zama-shi (JP)

(21) Appl. No.: 14/136,155

(22) Filed: Dec. 20, 2013

(30) Foreign Application Priority Data
Dec. 26, 2012 (JP) 2012-281900

(51) Int. Cl. H01M 10/48; G01M 3/00

(52) U.S. Cl. CPC H01M 10/48; G01M 3/00
USPC 73/23.2; 429/82

(57) ABSTRACT

[OBJECT] An object is to inspect leak of a film-sheathed battery 21 surely in a short time in a stage in which a battery module 1 has been assembled.

[SOLUTION TO PROBLEM] A battery module 1, which is formed by arranging a plurality of flat film-sheathed batteries 21 in layers and accommodating them in a case 11, has a slit at one end of a longitudinal direction, and a gas sensor 3 is inserted into this slit. A terminal portion 12 that is positioned at the other end of the longitudinal direction has a bolt hole that communicates with an inside of the case 11, and a blower 2 is connected to this bolt hole. Air is compulsorily introduced into the case 11 by the blower 2. The air passes through a periphery of the gas sensor 3, and flows out of the case 11. Therefore, the presence or absence of the leak can immediately be judged from an output of the gas sensor 3.

### TECHNICAL FIELD

The present invention relates to a leak detection method (a leak inspection method) that detects and inspects leak of electrolyte of a flat film-sheathed battery, and more particularly to a leak detection method (a leak inspection method) that, in a stage in which as a battery module a plurality of film-sheathed batteries are accommodated in a case, detects and inspects the leak of the film-sheathed batteries in the case. Further, the present invention relates to a battery module that is suitable for this leak detection method.

### BACKGROUND ART

There has been known a flat film-sheathed battery which is obtained by hermetically sealing, with a laminate film, a battery element formed by arranging a plurality of electrode plates that become positive and negative electrodes in layers through a separator, and by filling an inside of the sealed battery element with electrolyte. The laminate film has at least a metal layer and a heat-bonding layer (or a heat-sealing layer). Then, by heating and heat-bonding two laminate films together at an outer peripheral side of the battery element, a peripheral portion of the film-sheathed battery is sealed.

Such film-sheathed battery is generally handled as a battery module in which the plurality of film-sheathed batteries (e.g. four film-sheathed batteries) are accommodated in a case formed from, for instance, a metal plate. Although this battery module could be used singly, a plurality of battery modules are combined as stacked modules according to, for instance, a required voltage and use, and are accommodated in a pack case, than are used as a battery pack for, for instance, an electric vehicle.

In a case of such film-sheathed battery, if the laminate film is incompletely sealed, leak of the electrolyte filled in the inside of the laminate film occurs.

A Patent Document 1 discloses that a gas sensor that can detect gas components of the electrolyte is provided in an ageing device that performs ageing of a lithium-ion battery, and the leak of the electrolyte, which tends to occur in an ageing process, is detected.

### CITATION LIST

### Patent Document

[Patent Document 1]

Japanese Patent application Kokai Publication No. 2000-188135

### SUMMARY OF THE INVENTION

### Problems Solved by the Invention

However, the above conventional method is not suited to detect or inspect the leak in a state in which the plurality of film-sheathed batteries are accommodated in the case. That is, in the case of the method of the Patent Document 1, since the battery module is left as it stands for a long time in the ageing process, a sufficient time is secured. However, merely keeping an assembly state of the battery module for a long time for the leak inspection is not practical.

It is therefore an object of the present invention to provide a leak detection method (a leak inspection method) that can detect and inspect, in a short time, the presence or absence of the leak of the film-sheathed battery accommodated inside the battery module in the state of the battery module.

### Means to Solve the Problems

In the present invention, a method of inspecting leak or a film-sheathed battery in a battery module that is formed by arranging a plurality or flat film-sheathed batteries in layers and accommodating the film-sheathed batteries in a case, the method comprises: disposing a gas sensor with the gas sensor facing a first opening that is provided in the case; compulsorily introducing air into the case through a second opening that is provided in an other position of the case; and judging the presence or absence of the leak of the film-sheathed battery from an output of the gas sensor.

As one desirable embodiment, the air is press-sent into the case through the second opening by a blower. Or, as the other embodiment, the air in the case is sucked out through the first opening by negative pressure.

In a state in which a compulsory air flow is generated in the case of the battery module in this manner, if liquid or gas leak occurs at any film-sheathed battery in the case, gas components resulting from the leak of electrolyte flow to the first opening by the air flow. That is, if the leak occurs, the gas components surely and immediately flow around the gas sensor. It is thus possible to detect and inspect, in a short time, the presence or absence of the leak of the film-sheathed battery in the battery module.

The first opening and the second opening are arranged, for instance, on opposing wall surfaces of the case so that the air flow, flowing from the second opening that is an inlet of the air to the first opening that is an outlet of the air, flows while passing through a periphery of the film-sheathed battery. Regarding each opening, especially the second opening that is the inlet of the air, it is not necessarily one opening, and it could be possible to form the openings by a plurality of holes. Further, a plurality of first openings might be provided, then by setting the gas sensor for each first opening, the judgment of the leak is made from an output of each gas sensor.

It is desirable that the first opening and the second opening should be arranged on two side surfaces of the case, more specifically, on opposing two side surfaces of the case which face to each other along a main surface of the film-sheathed battery, then the air flows in a direction along the main surface of the film-sheathed battery in the case. With this setting, since the air smoothly flows between the adjacent film-sheathed batteries in the direction along their main surfaces, even if the leak occurs at any points of the film-sheathed batteries, the gas sensor surely detects the leak.

As the battery module suitable for such leak detection method (such leak inspection method), a battery module formed by arranging a plurality of flat film-sheathed batteries in layers and accommodating the film-sheathed batteries in a case, of the present invention, comprises: a first opening, formed in the case, for a gas sensor that inspects leak of the film-sheathed battery; and a second opening, formed in the case, to compulsorily flow air to the first opening in the case, and the first opening and the second opening are arranged on opposing two side surfaces of the case which face to each other along a main surface of the film-sheathed battery so that the air flows in a direction along the main surface of the film-sheathed battery in the case.

### Effects of the Invention

According to the present invention, since the air is compulsorily introduced into the case and flows in the case and the judgment of the presence or absence of the leak is made from the output of the gas sensor disposed at the first opening that is the outlet of the air flow, even if the battery module is in an assembled state, it is possible to surely detect and inspect the leak of the film-sheathed battery in a short time.

### BRIEF DESCRIPTION OF DRAWINGS

FIG. 1 is an explanatory drawing showing an embodiment of a leak detection method (or a leak inspection method) according to the present invention.

FIG. 2 is a flow chart of an operation of this leak detection method (or this inspection method).

FIG. 3 is a perspective view of a battery module used in a present embodiment.

FIG. 4 is a perspective view showing an end portion at an opposite side of the battery module.

FIG. 5 is a perspective view of a film-sheathed battery.

FIG. 6 is a perspective exploded view showing a plurality of film-sheathed batteries along with spacers.

FIG. 7 is a circuit diagram showing connection of four battery elements.

FIG. 8 is a vertically-cut cross section, cut along the middle of the battery module.

FIG. 9 is a vertically-cut cross section, cut at a side of the battery module.

FIG. 10 is an explanatory drawing of an embodiment using a negative pressure pump.

FIG. 11 is an explanatory drawing of an embodiment in which a position of an opening is changed.

### EMBODIMENTS FOR CARRYING OUT THE INVENTION

In the following description, embodiments of the present invention will be explained in detail with reference to the drawings.

FIG. 1 is an explanatory drawing showing an embodiment of a leak detection method (or a leak inspection method) of the present invention. A blower 2 that compulsorily introduces air into a battery module 1 that is an object of the inspection and a gas sensor 3 that detects gas components resulting from the leak of electrolyte are arranged so as to face to each other on a leak inspection stage on a manufacturing line. The blower 2 and the gas sensor 3 are each connected to a controller 4 that executes a leak detection (a leak inspection). This controller 4 has a readout (or an indicator) 5 that displays a result of the leak inspection, and also has an annunciator 6 that raises an acoustic alarm when detecting the leak.

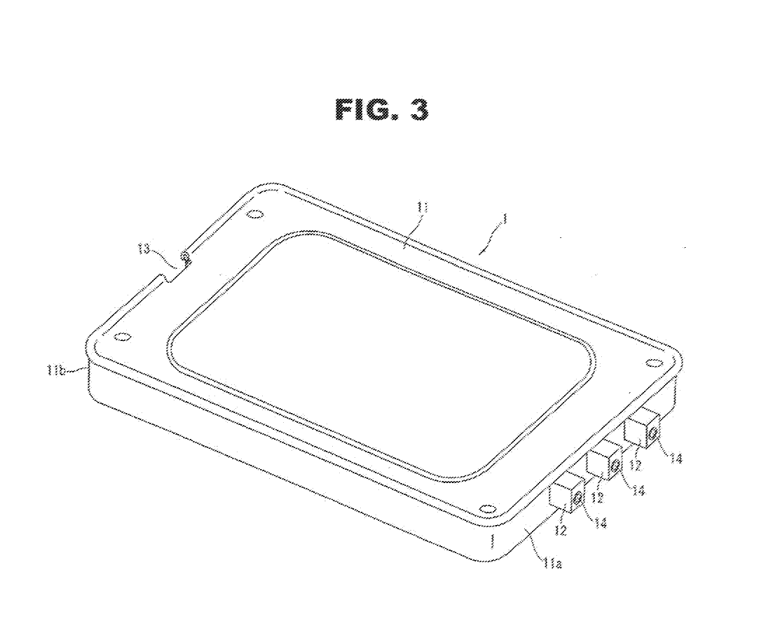

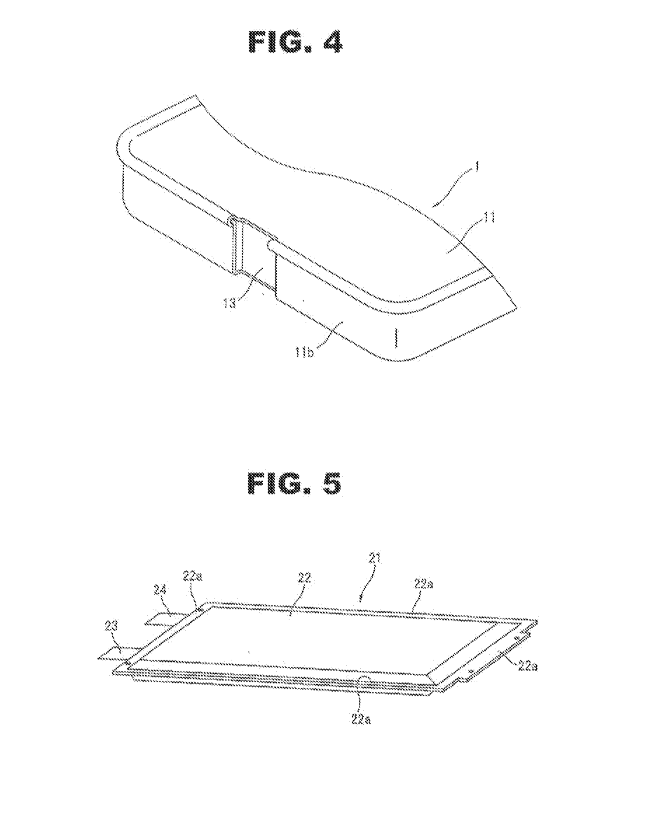

As shown in FIG. 3, the battery module 1 is a module that is formed by arranging flat film-sheathed batteries 21, e.g. four film-sheathed batteries, shown in FIG. 5 in layers and accommodating them in a rectangular flat case 11 formed from a metal plate. The battery module 1 is provided with three terminal portions 12 arranged side by side on a side surface 11a at a short peripheral side that is one end portion of a longitudinal direction. Further, as shown in FIG. 4, a rectangular slit 13 ranging over an overall height of the case 11 along a layered direction of the four film-sheathed batteries 21 is formed so as to open in the middle on a side surface 11b at the other short peripheral side that is the other end portion of the longitudinal direction. This slit 13 corresponds to a “first opening” recited in claims. The gas sensor 3 shown in FIG. 1 is disposed with its top end prober facing an inside of the case 11 through this slit 13.

The terminal portion 12 is formed so as to protrude from the side surface 11a of the case 11 and have a rectangular boss shape. A bolt hole 14 for connecting to a bus bar (not shown) is formed at a middle portion of each terminal portion 12. This bolt hole 14 penetrates the boss-shaped terminal portion 12 so as to reach an inside space of the case 11. Thus, the bolt hole 14 communicates with the inside space of the case 11. These three bolt holes 14 correspond to a “second opening” recited in claims. A discharge opening of the blower 2 shown in FIG. 1 is connected to each bolt hole 14 through a branch pipe 15 that branches into three.

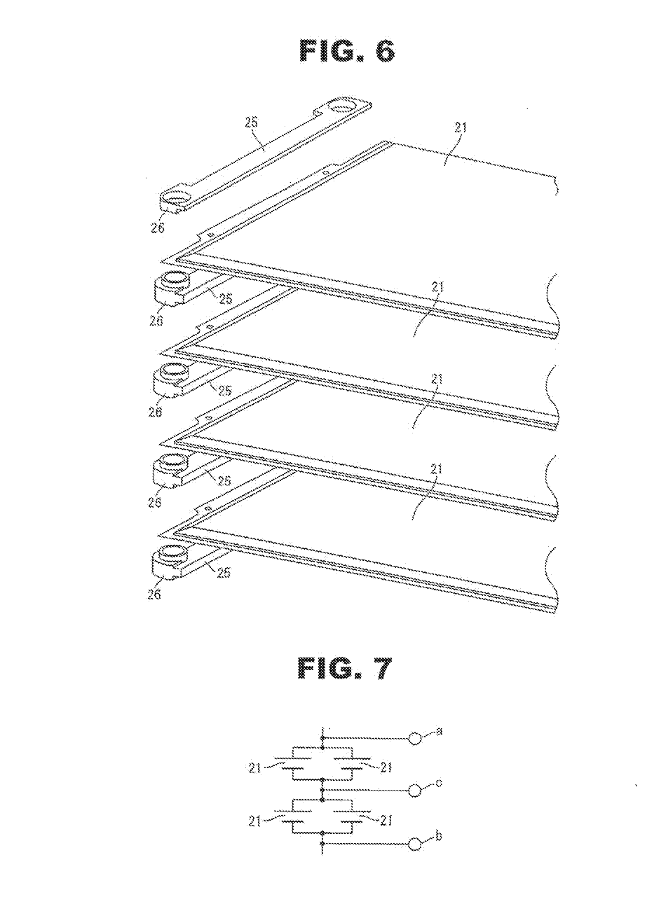

Here, regarding the four film-sheathed batteries 21 included in each battery module 1, as shown in FIG. 7, two parallel-arranged two film-sheathed batteries 21 are connected in series. Then, too terminal portions 12 located outside, of the three terminal portions 12, respectively correspond to terminals “a” and “b” located at both ends shown in FIG. 7 . The middle terminal portion 12 corresponds to an intermediate terminal “c”. This middle terminal portion 12, i.e. the intermediate terminal “c”, is used for monitoring voltage of each film-sheathed battery 21.

The film-sheathed battery 21 accommodated in the case 11 of the battery module 1 is, for instance, a lithium-ion secondary battery. As shown in FIG. 5, a battery element is formed by alternately arranging a rectangular positive electrode plate(s) and a rectangular negative electrode plate(s) in layers through a separator(s). This battery element is sandwiched between laminate films 22 that become a sheath film, and peripheries of these laminate films 22 are heat-bonded and sealed. The film-sheathed battery 21 has such flat shape, and a positive electrode tab 23 and a negative electrode tab 24 are drawn out from the laminate film 22 at one of both short peripheral sides of rectangular shape.

The laminate film 22 is a multilayer film including at least a heat-bonding layer (or a heat-sealing layer) located inside, an intermediate metal layer and a protective layer located outside. For instance, the heat-bonding layer is formed from polypropylene (PP), the metal layer is formed from aluminum foil, and the protective layer in formed from polyethlene terephthalate (PET). As one example, two rectangular laminate films 22 are disposed at both sides of the battery element, then by heat-bonding four sides of the laminate films 22, the film-sheathed battery 21 is formed. With this heat-bonding, a flat thin sealed portion 22a is formed at the four sides. As the other example, one laminate film 22 is folded in two, and the battery element is sandwiched inside the laminate film 22, then by heat-bonding the remaining three sides, the sealed film-sheathed battery 21 could be formed.

Here, the seal of the laminate film 22 by the heat-bonding is carried out with a filler port for filling of the electrolyte unsealed. After filling an inside with the electrolyte, the filler port is sealed. The electrolyte is formed from lithium salt such as lithium hexafluorophosphate (LiPF₆), and nonaqueous solvent such as ethylene carbonate, propylene carbonate, buthylene carbonate, vinylene carbonate, dimethyl carbonate, diethyl carbonate, ethyl methyl carbonate and methyl propyl carbonate.

As the gas sensor 3 to detect the leak of such electrolyte, as long as a sensor can sense gas components generated by liquid or gas leak of the electrolyte, the gas sensor 3 is not limited. Although this sensor is properly selected according to the electrolyte to be inspected, for instance, a hydrogen fluoride sensor that detects hydrogen fluoride generated by decomposition of the lithium salt and an odor sensor that detects organic components of the nonaqueous solvent could be used.

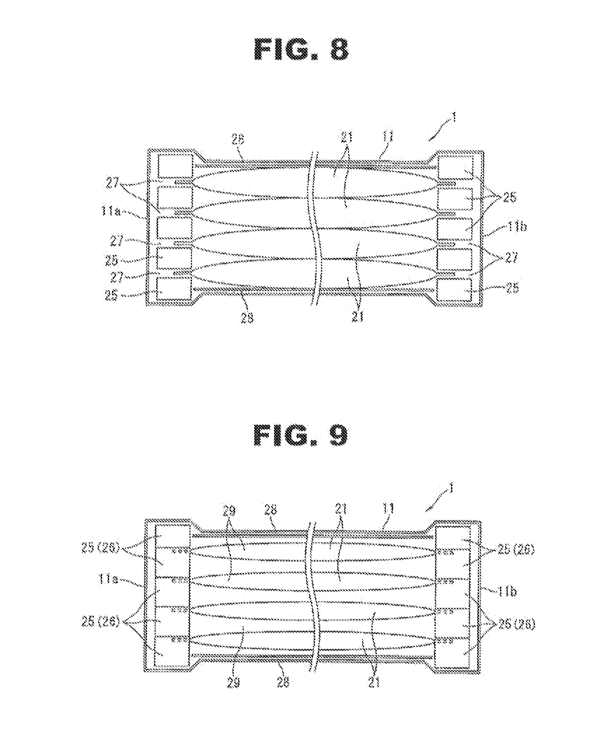

As shown in FIG. 6, the film-sheathed batteries 21 formed as described above are arranged in layers one by one through a spacer 25 that is disposed at both end portions of the longitudinal direction, and further these are accommodated in the case 11 with insulation sheets 28 (see FIG. 8) added onto a lowermost surface and an uppermost surface. Here, the positive electrode tab 23 and the negative electrode tab 24 of each film-sheathed battery 21 are connected to the respective terminal portions 12 of the end portion of the case 11 so as to form a circuit as shown in FIG. 7. The spacer 25 is a spacer that is molded into a shape along the short peripheral side of the film-sheathed battery 21 by insulative synthetic resin material. The spacer 25 has, at both ends thereof, cylindrical column portions 26. The column portions 26 of two spacers 25 which are adjacent to each other in the layered direction are fitted to and touch each other, thereby securing a space between the spacers 25, which secures a space between adjacent two film-sheathed batteries 21. Between the both end column portions 26, one spacer 25 and the other spacer 25 that is adjacent to the one spacer 25 are separated from each other in the layered direction, and therefore a gap in which air can flow remains.

FIG. 8 and FIG. 9 are explanatory drawings schematically showing such configuration of the inside of the case 11 including the spacer 25. Although each drawing is a sectional view of the battery module 1 when cut by a plane along the longitudinal direction of the case 11, FIG. 9 is a sectional view of the battery module 1 when cut along a plane passing through the column portion 26, and FIG. 8 is a sectional view of the battery module 1 when cut along a plane passing through a center of the spacer 25.

As shown in FIG. 9, in the cross section along the column portion 26, as mentioned above, the column portions 26 of all the spacers 25 are continuously contiguous with each other in the layered direction. In contrast to this, in the cross section along the center of the spacer 25 shown in FIG. 8, as mentioned above, a gap 27 is secured between the adjacent spacers 25.

On the other hand, when focusing attention on a thickness (i.e. a size in the layered direction) of the film-sheathed battery 21, a middle portion of each film-sheathed battery 21 bulges the most, and it gradually becomes thinner towards a periphery of the film-sheathed battery 21. Therefore, in the cross section along the center of the spacer 25 shown in FIG. 8, the adjacent film-sheathed batteries 21 are in contact with or touch each other in the middle portion. And also, the middle portion of the film-sheathed battery 21 is substantially in press-contact with upper and lower inner wall surfaces (a bottom surface and a ceiling surface) of the case 11 through the insulation sheet 28. In contrast to this, in the cross section along the column portion 26 shown in FIG. 9, since the thickness of each film-sheathed battery 21 is decreased to some extent, a certain gap 29 appears between the adjacent film-sheathed batteries 21.

The three bolt holes 14 that are inlets of the air by the blower 2 are positioned at the one side surface 11a of the case 11 shown in FIGS. 8 and 9. The slit 13 that is an outlet of the sir where the gas sensor 3 is disposed is positioned at the other side surface 11b. These two side surfaces 11a and 11b face to each other along a main surface (a basic plane along which the positive electrode plate etc. extend) of the film-sheathed battery 21. Thus, the air flowing from the one side surface 11a into the case 11 crosses the spacer 25 through the gap 27 between the spacers 25, and flows in a direction along the main surface of the film-sheathed battery 21 through the gap 29 appearing between the film-sheathed batteries 21. Further, the air flows to the slit 13 that is the outlet of the air through the gap 27 between the spacers 25 located at the opposite side of the case 11. Therefore, the air flows relatively smoothly in the case 11 in which the plurality of film-sheathed batteries 21 are arranged in layers and accommodated. Further, even if the leak occurs at any points of each film-sheathed battery 21, the gas components generated by the leak surely contact the airflow, then the detection by the gas sensor 3 disposed at the outlet of the air becomes possible.

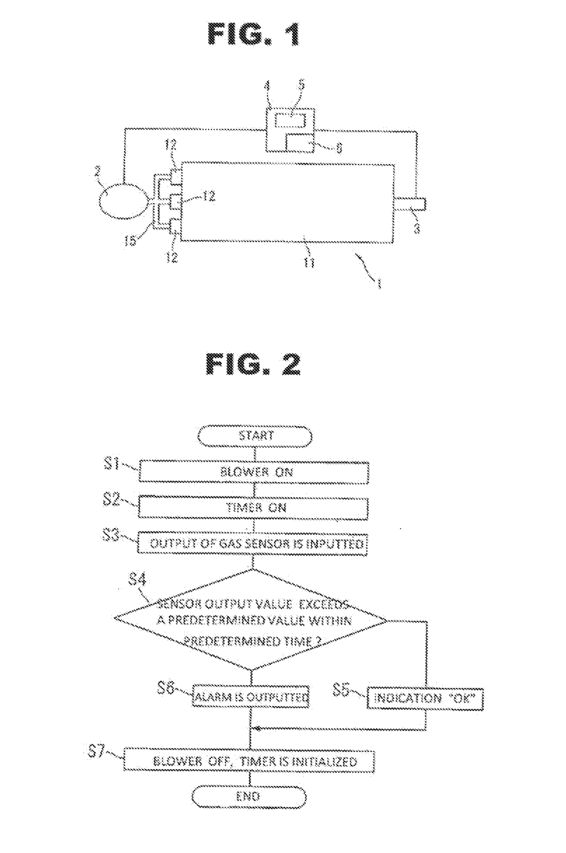

FIG. 2 is a flow chart showing a flow of an operation of the leak detection (the leak inspection) executed by the controller 4 shown it FIG. 1.

This leak inspection is carried out, for instance, on an automated line. When a completed battery module 1 is transferred to the leak inspection stage by a carrier line, a top end of the branch pipe 15 is inserted into each bolt hole 14 of the terminal portion 12, and also the top end prober of the gas sensor 3 is inserted into the slit 13 located as the opposite side. Then, the operation of FIG. 2 is started in this state. At step S1, the blower 2 is switched ON. At step S2, a timer is started. Further, at step S3, an output of the gas sensor 3 is read.

By working of the blower 2, the air (outside air) is compulsorily introduced into the case 11 through the three bolt holes 14. As mentioned above, this air flows in the direction along the main surface of each film-sheathed battery 21. That is, the air flows along the longitudinal direction in the case 11, and flows out to the outside from the slit 13 that opens on the side surface 11b located at the opposite side to the terminal portion 12. Thus, if the leak occurs at any film-sheathed batteries 21, the gas components resulting from the leak of the electrolyte immediately act on the gas sensor 3 by riding the air flow, then the gas components are detected by the gas sensor 3.

At step S4, a judgment is made as to whether or not the output of the gas sensor 3 exceeds a predetermined threshold value within a predetermined time. If the output exceeding the threshold value is not detected, the routine proceeds to step S5, and an indication of no leak is shown by the readout 5. If the output exceeding the threshold value is detected, the routine proceeds to step S6, and an indication of occurrence of the leak is shown by the readout 5, and at the same time the alarm is raised by the annunciator 6 to give an operator a notice of the leak. Here, in the case of the automated line, it is desirable that the line should be configured to automatically exclude the battery module 1 that is judged to be the leak. As the predetermined time at step S4, it is a few seconds, and it could be the order of tens of seconds at the longest.

After steps S5 and S6, at step S7, the blower 2 is switched OFF, and the timer is initialized, then a series of operation is terminated.

As described above, according to the present invention, it is possible to detect and inspect, surely and efficiently in a short time, the presence or absence of the leak of the film-sheathed battery 21 in a state in which the battery module 1 has been assembled. As a consequence, the leak inspection in a stage rather close to a stage of a final shipment becomes possible. For instance, regarding a leak that newly occurs when the film-sheathed battery 21 is assembled as the battery module 1, this leak can be detected.

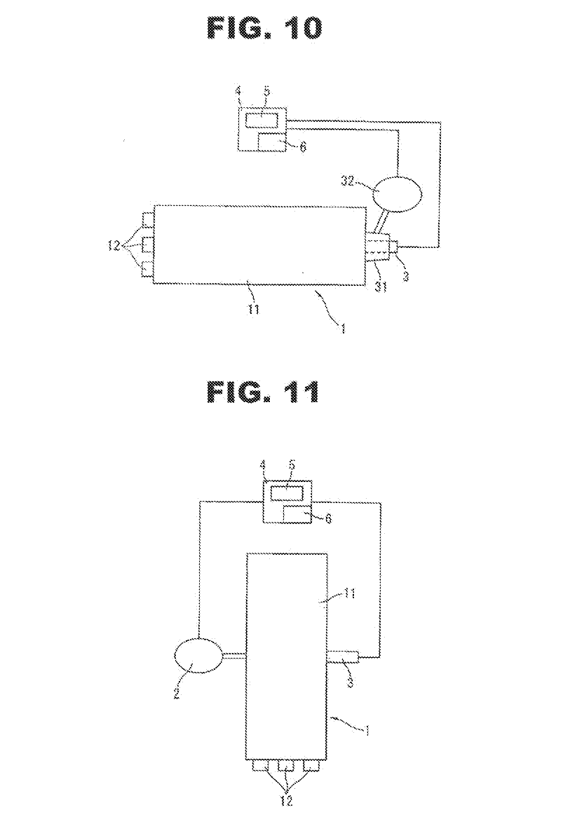

Here, in the above embodiment, the outside air is compulsorily sent into the case 11 by the blower 2. However, conversely, it could be configured to discharge or suck out the air from the inside of the case 11 by negative pressure. FIG. 10 shows one embodiment in which the air is sucked out by the negative pressure. A rubber boot 31 that covers the slit 13 at the end portion of the case 11 is fixed to a top end portion of the gas sensor 3, and a negative pressure pump 32 is connected to this rubber boot 31. Thus, when the top end portion of the gas sensor 3 is inserted into the slit 13, the slit 13 is covered by the rubber boot 31 at the same time, and the air in the case 11 is sucked out according to working of the negative pressure pump 32. Because of this, the outside air is introduced into the case 11 from the bolt hole 14 corresponding to the second opening. Then, as same as the embodiment described above, the air flows in the direction along the main surface of the film-sheathed battery 21 in the case 11, and passes through a periphery of the gas sensor 3. If the leak occurs at any film-sheathed batteries 21, as same as the above embodiment, the leak can immediately be detected on the basis of the output of the gas sensor 3.

Here, in the case of this embodiment, as long as the second opening merely opens no the outside air, it is not limited. Thus, for instance, instead of the bolt hole 14, an existing hole or gap in the case 11 could be used as the second opening.

In order to flow the air throughout the inside of the case 11, it is preferable that the first opening be arranged at one of the short peripheral sides and the second opening be arranged at the other of the short peripheral sides so that the air flows along the longitudinal direction of the long narrow case 11, like the above embodiments. However, the present invention is not limited to this. As long as the air surely flows around the film-sheathed battery 21 and passes through the gas sensor 3, any arrangement can be possible. Further, each shape of the first opening and the second opening can also be changed arbitrarily.

FIG. 11 is a configuration, as one embodiment, in which the first opening for the gas sensor 3 is provided on one side surface that is a long peripheral side of the long narrow case 11, and the air is compulsorily sent into the case 11 from the second opening that is provided on the other side surface that faces to the one side surface by the blower 2. Also in the case of this configuration, the leak inspection is sufficiently possible. Further, a plurality of first openings and a plurality of gas sensors 3 might be arranged as necessary.

However, when the first opening and the second opening are provided on the bottom surface and the ceiling surface of the case 11 respectively and the air flows in the layered direction of the film-sheathed battery 21, the insulation sheet 28 shown in FIGS. 8 and 9 interferes with the air flow. And also, as shown in FIGS. 8 and 9, the plurality of film-sheathed batteries 21 exist in a direction orthogonal to the air flow. Thus, an air-flow resistance becomes large, and this configuration is generally an undesirable configuration.

### EXPLANATION OF REFERENCE

1 . . . battery module

2 . . . blower

3 . . . gas sensor

4 . . . controller

1. A method of inspecting leak of a film-sheathed battery in a battery module that is formed by arranging a plurality of flat film-sheathed batteries in layers and accommodating the film-sheathed batteries in a case, the method comprising:
disposing a gas sensor with the gas sensor facing a first opening that is provided in the case;
compulsorily introducing air into the case through a second opening that is provided in an other position of the case; and
judging the presence or absence of the leak of the film-sheathed battery from an output of the gas sensor.

2. The method of inspecting the leak of the film-sheathed battery as claimed in claim 1, wherein
the first opening and the second opening are arranged on opposing two side surfaces of the case which face to each other along a main surface of the film-sheathed battery, and
the air flows in a direction along the main surface of the film-sheathed battery in the case.

3. The method of inspecting the leak of the film-sheathed battery as claimed in claim 1, wherein
the air is press-sent into the case through the second opening by a blower.

4. The method of inspecting the leak of the film-sheathed battery as claimed in claim 1, wherein
the air in the case is sucked out through the first opening by negative pressure.

5. A battery module formed by arranging a plurality of flat film-sheathed batteries in layers and accommodating the film-sheathed batteries in a case, comprising:
a first opening, formed in the case, for a gas sensor that inspects leak of the film-sheathed battery; and
a second opening, formed in the case, to compulsorily flow air to the first opening in the case, and
the first opening and the second opening being arranged on opposing two side surfaces of the case which face to each other along a main surface of the film-sheathed battery so that the air flows in a direction along the main surface of the film-sheathed battery in the case.
